(19) United States
(12) Patent Application Publication
(10) Pub. No.: US 2010/0090459 A1
(43) Pub. Date: Apr. 15, 2010

(54) QUICK ACTUATING FITTING FOR CORRUGATED STAINLESS STEEL TUBING

(75) Inventors: Scott Duquette, Enfield, CT (US); Franz Kellar, Gastonia, NC (US); Harold Crowder, Concord, NC (US)

Correspondence Address: EDWARDS ANGELL PALMER & DODGE LLP, P.O. BOX 55874, BOSTON, MA, 02205, US

(73) Assignee: TITEFLEX CORPORATION, Springfield, MA (US)

(21) Appl. No.: 12/515,905

(22) PCT Filed: Nov. 16, 2007
(86) PCT No.: PCT/US2007/084936

§ 371 Date: Dec. 23, 2009

Related U.S. Application Data
(60) Provisional application No. 60/860,659, filed on Nov. 21, 2006.

(51) Int. Cl. F16L 9/14

(52) U.S. Cl. 285/55

(57) ABSTRACT

A fitting (14) incorporating a quick actuating sealing and locking device and methods of actuating the fitting and forming a seal between a length of corrugated tubing (10) and the fitting (14) are provided. The tubing (10) can be corrugated stainless steel tubing having a jacket (12) that at least partially covers the tubing. The sealing and locking device incorporates a sealing ring (24) and a loading ring (26)—received in the fitting (14), the sealing ring (24) being compressible against an end corrugation of the tubing—. The loading ring (26) can be actuated to move axially and engage the sealing ring (24), thereby compressing the sealing ring (24) into substantial engagement with the end corrugation.

### CROSS-REFERENCE TO RELATED APPLICATION

This application claims the benefit of copending application U.S. Provisional Application Ser. No. 60/860,659 filed on Nov. 21, 2006, the disclosure of which is expressly incorporated herein by reference in its entirety.

### FIELD OF INVENTION

The present invention relates to gas and liquid piping systems, and more particularly to a fitting incorporating a quick actuating sealing and locking device for forming a seal between a length of corrugated tubing and the fitting.

### BACKGROUND OF THE INVENTION

Gas and liquid piping systems which utilize corrugated stainless steel tubing (“CSST”) and fittings are known. Such piping systems can be designed for use in combination with elevated gas pressures of up to about 0.03 megapascals (MPa) or more, and provide advantages over traditional rigid black iron piping systems in terms of ease and speed of installation, elimination of onsite measuring, and reduction in the need for certain fittings such as elbows, tees, and couplings. Undesirably, some fittings conventionally used with CSST systems include fiber sealing gaskets or polymer O-rings which can deteriorate over time, or pre-flared tubing ends, which suffer from reliability problems.

A suitable self-aligning and self-flaring fitting assembly, which does not require the use of a sealing gasket, is disclosed in U.S. Pat. No. 6,173,995 to Mau (“the '995 patent”), which is incorporated by reference herein. The '995 patent is owned by Titeflex Corporation, assignee of the present application, and discloses a self-flaring fitting assembly for use with semi-flexible, convoluted tubes or pipes, including CSST systems. The fitting assembly includes an externally-threaded adapter having a pipe receiving bore divided into a plurality of sections of different diameters, a nut threaded to a first end of the adapter, and a split bushing assembly with at least two internally spaced ribs for engaging circumferential grooves of the corrugated tubing, as shown in FIGS. 2-5 of the '995 patent. The fitting assembly disclosed in the '995 patent forms a seal by compressing an end corrugation or convolution between an internal stop shoulder of the adapter and one end of the split bushing assembly. A seal formed according to the above mechanism may be suitable for preventing leaking of gas and/or liquid through the pipe and fitting connection. However, in some instances, excessive torque may be required to create a seal on certain types of tubing, and/or it may be desirable to form a seal by using other fitting geometries that do not require crushing one or more corrugations of the tubing. It would also be desirable to generate a uniform force, per circumferential unit distance, sealing interface that can provide a known sealing pressure per unit area of corrugated sealing surface engaged.

It would be desirable to provide a fitting having a suitable sealing mechanism for connecting the fitting to a length of tubing. Such a fitting preferably could be adapted for use with different types of tubing and fitting interfaces and other piping and tubing systems, particularly those designed for transporting gas and/or liquid.

In some fittings designed for use with CSST systems, an end corrugation of the tubing is compressed to form a metal-to-metal seal. Examples of such sealing arrangements include U.S. Pat. No. 6,428,052 to Albino et al., U.S. Pat. No. 6,877,781 to Edler, and U.S. Pat. No. 6,908,114 to Moner. However, especially when larger sized fittings are used, a problem arises that the fittings require high amounts of torque to form an adequate seal with a length of tubing.

It would be desirable to provide an improved fitting configured for connection to a length of corrugated tubing, where the fitting incorporates a quick actuating sealing and locking device. The fitting and related devices and methods should overcome the deficiencies of the presently available fittings and sealing arrangements, for which it can be difficult to produce a suitable amount of torque, and in which a suitable circumferential sealing force per unit area has not heretofore been achieved.

### SUMMARY OF THE INVENTION

A fitting incorporating a quick actuating sealing and locking device for forming a seal between a length of corrugated tubing and the fitting, and methods of actuating the fitting and forming a seal using the fitting and tubing are disclosed. The tubing can be corrugated stainless steel tubing (CSST) commonly used in gas and liquid piping systems. The tubing can be at least partially covered with a jacket, where at least one end corrugation can be uncovered in order to adequately form a seal. According to the present invention, a suitable seal can be formed without crushing one or more corrugations of the tubing, and without requiring excessive torque to form the seal. According to the invention, a suitable seal can be formed inside the fitting, and a predetermined sealing pressure per unit area preferably is applied to a sealing interface.

The fitting of the invention can include at least an adapter or body member, and a sleeve member. The sleeve member can be affixed to the adapter by using any of a number of known techniques, including but not limited to crimping, groove sealing, press fitting, and brazing.

Preferably the adapter is affixed to a first or proximal end of the sleeve member, where a second or distal end of the sleeve member is configured to receive the tubing. As used herein, the proximal end of the sleeve member refers to that end closest to the adapter, whereas the distal end of the sleeve member refers to that end closest to an interface between the fitting and the tubing. At the distal end of the sleeve member, the sleeve member preferably is formed with a plurality of jacket locking fingers that can be crimped to the tubing after insertion of the tubing into the fitting.

The tubing can be inserted into the sleeve member of the fitting, and advanced proximally through the sleeve member. The sleeve member is configured to receive internally a sealing ring and a loading ring. Preferably the sealing ring abuts a portion of the adapter received within the sleeve member, where the sealing ring is positioned radially inside the sleeve member. The loading ring can be arranged near or adjacent to the sealing ring inside the sleeve member, where the loading ring extends distally from the sealing ring.

During insertion of the tubing into the fitting, the tubing is pushed forward in the proximal direction until an end corrugation of the tubing engages the sealing ring. An axial actuation tool can be used to grip the sleeve member and advance the loading ring, thus compressing and deforming the sealing ring to contact substantially the entire periphery of the end corrugation. The sleeve member can be formed with locking tabs, such that the loading ring is advanced until the locking tabs are engaged with corresponding parts of the loading ring. Alternatively, it is possible to provide the locking tabs on another component, or substitute another engagement or locking or loading mechanism.

A sealing device for connecting a length of corrugated tubing to a fitting can include the fitting having a sleeve member for receiving the tubing, a sealing ring received in the sleeve member, the sealing ring configured to be compressed by at least one corrugation of the tubing, and a loading ring configured to engage the sealing ring and compress the sealing ring against the at least one corrugation of the tubing.

A sealing device according to the invention can be implemented in a fitting for connecting to a length of corrugated tubing, where the fitting may encompass different variations including a single fitting terminating in an adapter, a dual-end fitting for receiving two separate lengths of corrugated tubing, or a union configuration.

A method for connecting a length of corrugated tubing to a fitting, comprising the steps of: providing a sleeve member for receiving the tubing, the sleeve member being formed with a compressible sealing ring and a loading ring for engaging the sealing ring; inserting the tubing into the sleeve member; and actuating the loading ring to move axially and compress the sealing ring against at least one corrugation of the tubing. The method can further include steps of: locking the sleeve member against the loading ring, and forming at least one crimp in the sleeve member at an interface between the sleeve member and the tubing.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 is a perspective view of a length of corrugated tubing received in a fitting, which incorporates a quick actuating sealing and locking device according to a preferred embodiment of the present invention;

FIG. 2 is a cross-sectional view of the tubing and fitting depicted in FIG. 1.

FIG. 3 is the same cross-sectional view as depicted in FIG. 2, but includes portions marked for enlargement in subsequent figures;

FIG. 4A is an enlarged cross-sectional view of a specified portion of the tubing and fitting depicted in FIG. 3;

FIG. 4B is a further enlarged cross-sectional view of another specified portion of the tubing and fitting depicted in FIG. 3;

FIG. 5A is a cross-sectional view of the tubing and fitting of FIG. 1 prior to insertion of the length of corrugated tubing into the fitting;

FIG. 5B is a cross-sectional view of the tubing and fitting of FIG. 1 in which the tubing has been advanced to an inner ring;

FIG. 5C is a cross-sectional view of the tubing and fitting of FIG. 1 depicting a fully assembled fitting as shown in FIG. 2;

FIG. 6A is a cross-sectional view of a length of corrugated tubing received in a fitting according to another preferred embodiment of the present invention; and

FIG. 6B is an enlarged cross-sectional view of a specified portion of the tubing and fitting depicted in FIG. 6A.

### DEFINITIONS

The instant invention is most clearly understood with reference to the following definitions:

As used in the specification and claims, the singular form “a”, “an” and “the” include plural references unless the context clearly dictates otherwise.

As used herein, the terms “corrugated stainless steel tubing” and “CSST” refer to any type of semi-flexible tubing or piping, which may accommodate corrosive or aggressive gases or liquids, and includes but is not limited to semi-flexible tubing or piping made from: thermoplastics, metal or metal alloy materials such as olefin-based plastics (e.g., polyethylene (PE)), fluorocarbon polymers (e.g., polytetrafluoroethylene (PTFE)), carbon steel, copper, brass, aluminum, titanium, nickel, and alloys thereof.

### DETAILED DESCRIPTION OF THE INVENTION

A fitting incorporating a quick actuating sealing and locking device for forming a seal between a length of corrugated tubing and the fitting, and methods of actuating the fitting and forming a seal using the fitting and tubing are disclosed. The tubing can be corrugated stainless steel tubing (CSST) commonly used in gas and liquid piping systems. The tubing can be at least partially covered with a jacket. According to the present invention, a suitable seal can be formed without crushing one or more corrugations of the tubing, and without requiring excessive torque to form the seal. Instead, a suitable seal can be formed inside the fitting, and a predetermined sealing pressure per unit area preferably is applied to a sealing interface on the tubing exterior.

A fitting according to the present invention includes at least an adapter or body member, and a sleeve member. The sleeve member preferably can be attached to the adapter during manufacturing, for example, by using any of a number of common techniques, in order to form a fluid tight seal between the sleeve member and the adapter. For example, the sleeve member can be affixed to the adapter by crimping, or the sleeve member can be press fit to the outer diameter of the adapter. Further suitable techniques for connecting the sleeve member and the adapter include brazing and welding. Additionally or alternatively, a compound such as a resin, adhesive, or epoxy can be applied to an interface between the sleeve member and the adapter to form a suitable bond. Optionally, the interface between the sleeve member and adapter can include an O-ring, gasket, or other elastomeric material. As an alternative to providing the sleeve member and adapter as separate components, a single integral sleeve member and adapter can be used.

Preferably the adapter is affixed to a first or proximal end of the sleeve member, where a second or distal end of the sleeve member is configured to receive the tubing. As used herein, the proximal end of the sleeve member refers to that end closest to the adapter, whereas the distal end of the sleeve member refers to that end closest to an interface between the fitting and the tubing. At the distal end of the sleeve member, the sleeve member optionally can be formed with a jacket lock configuration, which may contain a plurality of jacket locking fingers. Preferably the jacket locking fingers of the sleeve member can be attached to the tubing by crimping. Alternatively, the fingers can be held open by an outside diameter of the loading ring. When the loading ring is advanced forward to compress the sealing ring, the jacket lock fingers are allowed to close in radially, thus locking the jacket. In other words, the fingers can be biased to engage the jacket when the loading ring is advanced. In other embodiments, the fingers can be replaced with a substantially continuous cross-section of the sleeve member that is crimped to the tubing.

Prior to crimping or otherwise attaching the distal end of the sleeve member to the tubing, the tubing can be received in the fitting. In particular, the tubing is inserted into the sleeve member, and advanced in the proximal direction through an inner portion of the sleeve member, i.e., inside the sleeve member. The inner portion of the sleeve member preferably is configured to receive a sealing ring and a loading ring. The sealing ring can abut a portion of the adapter received inside the sleeve member, where the sealing ring is contained entirely within the sleeve member. The loading ring can be arranged near or adjacent to the sealing ring, the loading ring extending distally from the sealing ring.

Prior to insertion of the tubing, the sealing ring and the loading ring are in an uncompressed state. Thereafter, during insertion of the tubing into the sleeve member, the tubing is pushed forward in the proximal direction until an end corrugation of the tubing engages the sealing ring. An axial actuation tool can be used to grip the sleeve member and advance the loading ring, thus compressing and deforming the sealing ring to enclose and thus contact the end corrugation around substantially the entire periphery of the end corrugation. Finally, the loading ring is advanced axially in the proximal direction until locking tabs of the sleeve member engage corresponding enclosures or the aft face of the loading ring. Alternatively, it is possible to provide the locking tabs on the loading ring or another component, or substitute a different locking mechanism.

Upon full insertion of the tubing into the fitting, sealing can be performed by using either a specialized hand tool or power tool. The jacket locking fingers of the sleeve member can be engaged with the tubing, thereby forming a jacket lock. Other jacket relief and strain relief mechanisms, for example, those that do not require crimping, can also be used.

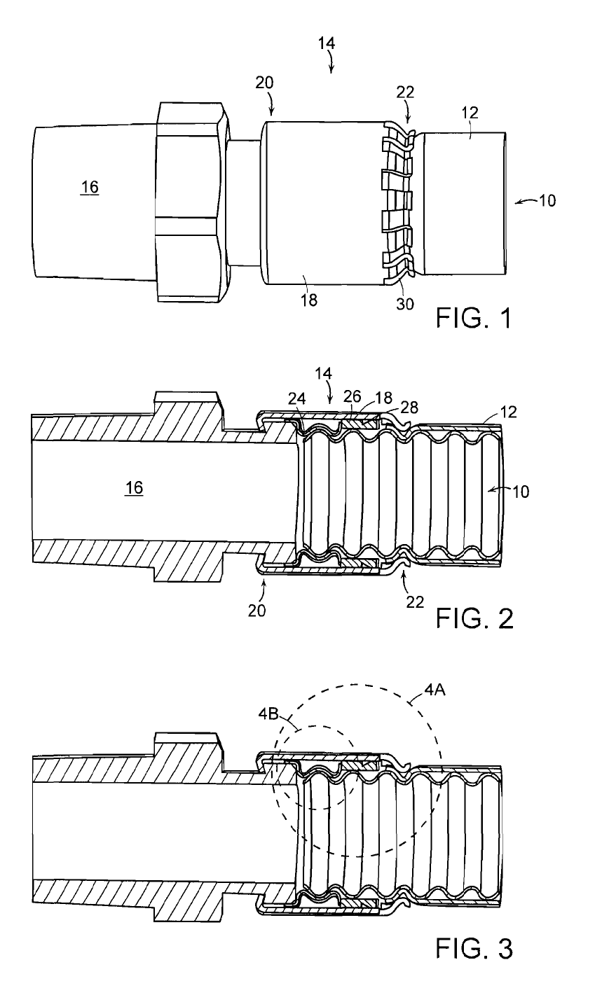

Referring to FIGS. 1 and 2, a length of corrugated tubing 10 preferably is at least partially covered by a jacket 12, where the tubing 10 and jacket 12 can be received in a fitting 14. The tubing 10 can be corrugated stainless steel tubing (CSST) commonly used for transporting gas and liquid, and the jacket 12 can be made of any suitable material, for example, polyethylene. Optionally, the tubing 10 can be provided without a jacket. In certain embodiments, the jacket 12 can be peeled back from an end of the tubing 10, thereby exposing one or more corrugations of the tubing 10.

The fitting 14 preferably includes at least an adapter (or body member) 16 and a sleeve member 18. The sleeve member 18 can be crimped to the adapter 16 or attached in any suitable manner, for example, by press fitting, bonding, brazing, or welding, and preferably prior to inserting the tubing 10 and jacket 12 into the fitting 14. The sleeve member 18 preferably is made of metal or a metal alloy, but can be made of other formable materials such as plastics, polymers or elastomers.

The sleeve member 18 has a proximal end 20 and a distal end 22, the proximal end 20 being located near or adjacent to a connection between the adapter 16 and the sleeve member 18, where the distal end 22 is located away from the adapter/sleeve member interface. Preferably, the distal end 22 is located closest to an interface between the sleeve member 18 and tubing 10.

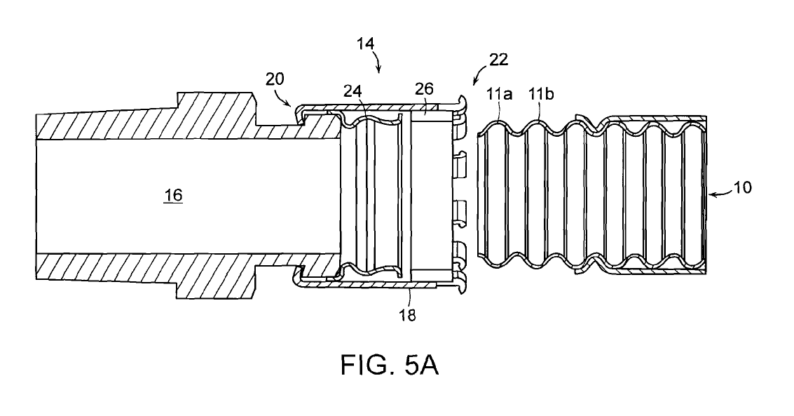

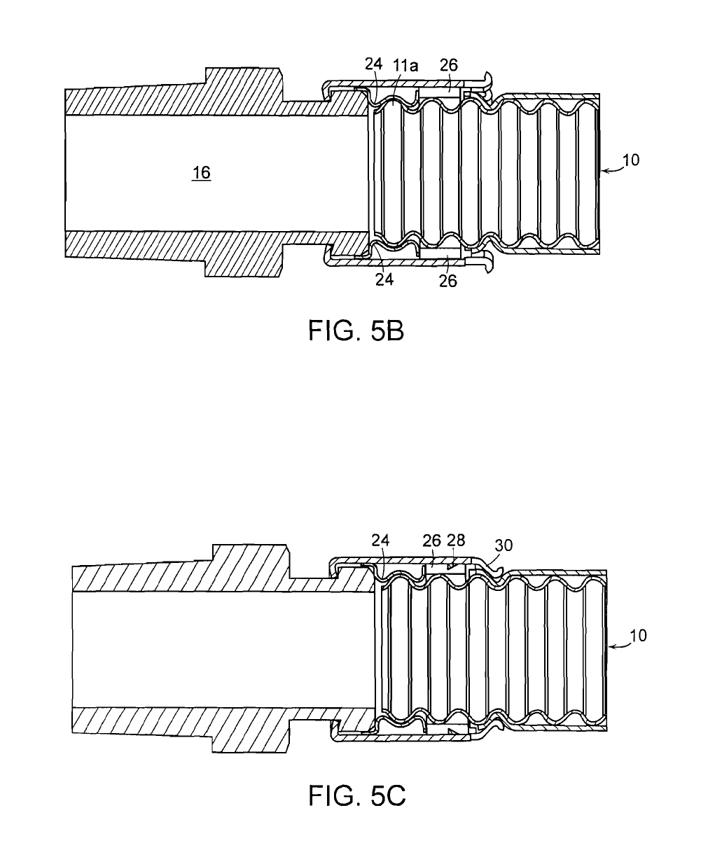

In the embodiment depicted in FIG. 2, a portion of the jacket 12 has been stripped away from one or more corrugations of the tubing 10 inserted into the fitting 14, such that one or more end corrugations of the tubing 10 inserted proximally into the sleeve member 18 are uncovered. For example, in FIG. 2, first and second corrugations or peaks 11a and 11b are uncovered (see FIG. 5A). The remaining one or more corrugations 11 received in the fitting 14 optionally can be covered by the jacket 12, as shown in FIG. 5A. At least the first corrugation 11a can be received in a quick actuating sealing and locking device of the present invention.

FIG. 2 depicts the fitting 14 incorporating the quick actuating sealing and locking device. The sealing and locking device preferably includes at least an inner sealing ring 24 provided at approximately the proximal end 20 of the sleeve member 18, and a loading ring 26 positioned distally of the sealing ring 24. The sealing ring 24 and the loading ring 26 preferably are in close proximity, and may directly contact each other. The sealing ring 24 preferably is located radially inside the sleeve member 18, and can extend around substantially the entire circumference of the tubing 10. In alternate embodiments, it is possible for the sealing ring 24 to extend only partially around the tubing 10, and thus not fully enclose the tubing 10. The sealing ring 24 preferably is made of a material that is metallic or has metallic properties, including but not limited to metals, metal alloys, plastics, polymers, and elastomers. In preferred embodiments of the quick actuating sealing and locking mechanism, the sealing ring 24 is made of a formable material, the sealing ring being configured and/or shaped to receive at least one corrugation of the tubing 10. The loading ring 26 also preferably extends along the inside of the sleeve member 18, preferably fully enclosing, but at least partially enclosing, the tubing 10.

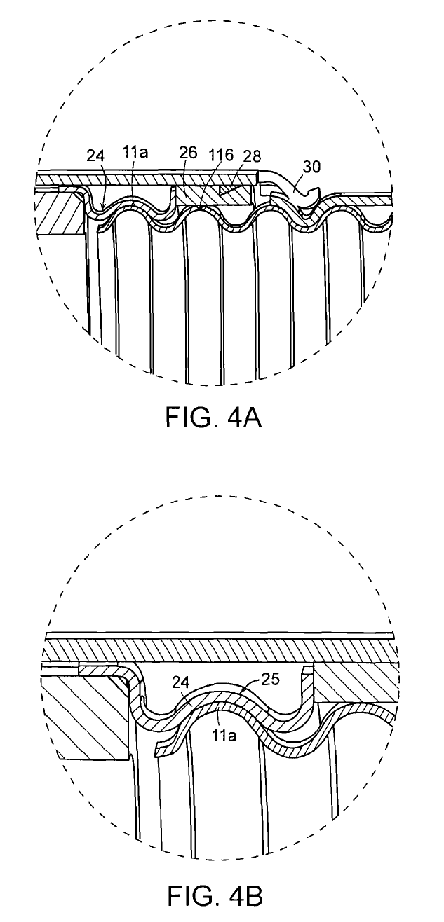

Enlarged views of the sealing ring 24 and the loading ring 26 are provided in FIGS. 4A and 4B based on the circled portions of FIG. 3. The sealing ring 24 preferably is deformable, and configured to receive at least the first corrugation 11a of the tubing 10 inserted into the fitting 14. The sealing ring 24 can include an arc-like portion 25 positioned radially inside the sealing ring toward the tubing 10 for receiving the first corrugation 11a, such that engagement of the first corrugation 11a within the arc-like portion will restrain further axial movement of the tubing 10. The sealing ring can form a compressive arc of contact on top of the corrugation, or can be configured to form two axially opposing arcs of contact on either side of the corrugation 11. The loading ring 26 can be positioned near or adjacent to the sealing ring 24, or it is possible to include one or more intervening parts. The loading ring 26 can provide axial actuation and support to the sealing ring 24 and the fitting 14 generally. The sleeve member 18 preferably is provided with one or more locking tabs 28 configured for engagement with corresponding enclosures of the loading ring 26.

In operation, axial actuation of the fitting and sealing of the fitting to the tubing will be described with reference to FIGS. 5A to 5C. As shown in FIG. 5A, in an initial state, prior to insertion of the tubing 10 into the fitting 14, the sealing ring 24 and the loading ring 26 are in an uncompressed, expanded state. Preferably the jacket 12 is stripped from one or more end corrugations of the tubing 10, thereby exposing first and second corrugations 11a and 11b, respectively, for example. Also prior to insertion, it is possible to connect an opposite end (i.e., the end not connected to the sleeve member 18) of the adapter 16 to a desired terminal location, such as an appliance, iron pipe, or other location (not shown). Then, the tubing 10 preferably with uncovered first and/or second corrugations 11a, 11b is inserted axially into the distal end 22 of the sleeve member 18. The tubing 10 is advanced proximally through the inside of the sleeve member 18 until the first corrugation 11a engages the sealing ring 24, thereby substantially restraining further movement of the tubing 10.

After engagement of at least the first corrugation 11a with the sealing ring 24, an axial actuation tool (not shown) such as a specialized set of pliers or a power tool can be placed around the outside of the sleeve member 14 in approximately the area of the loading ring 26. Then, the loading ring 26 can be advanced proximally toward the sealing ring 24, thus compressing and deforming the sealing ring 24, and causing the sealing ring 24 to substantially engage the entire periphery of the first corrugation 11a (see FIG. 5B). The loading ring 26 is advanced proximally until the locking tabs 28 of the sleeve member 18 engage corresponding enclosures of the loading ring 26 (see FIG. 5C).

After the tubing 10 has been fully inserted into the fitting 14, it is desirable to fixedly connect or lock the tubing to the fitting along an interface between the sleeve member 18 and the tubing 10 at the distal end 22 of the sleeve member 18, thus preventing disengagement of the sleeve member 18 and the tubing 10. A predetermined sealing pressure per unit area can be applied to the interface between the sleeve member 18 and the tubing 10. As shown in FIG. 5C, a jacket lock has been formed by connecting a plurality of jacket fingers 30 of the sleeve member 18 to a portion of the jacket 12 covering the tubing 10. The jacket lock can also be formed by having the loading ring hold the normally closed fingers in an open state while the loading ring is in the initial position. Once the loading ring is advanced forward, the corrugation will contact the fitting axial stop and the fingers will close on the tubing jacket as the fingers restore to the normally closed position.

A jacket crimp formed by the jacket fingers 30 is shown, for example, in FIG. 1. The jacket fingers 30 on at least the distal end of the sleeve member 18 can be crimped to the jacket 12 covering the tubing 10. The jacket crimp can be formed by connecting the jacket fingers 30 to the tubing 10 in a valley located between two corrugations (see, e.g., FIG. 4A). The jacket crimp can be formed with the jacket fingers 30 that are either continuous or notched, or the jacket fingers 30 can be replaced by a continuous end portion of the sleeve member 18. Preferably the jacket crimp extends substantially around an outer diameter of the jacket and tubing, in order to fix the sleeve member 18 to the jacket 12. The jacket crimp 30 provides a locking function, thereby preventing axial movement of the jacket 12 in a direction away from the fitting 14. The jacket crimp 30 can provide strain relief for the sealing area around the corrugation peaks 11. Alternatively, a sealing or connecting technique other than crimping can be used.

According to the present invention, the sealing or connecting operation generally takes place after a manual loading ring axial advance operation is performed, for example, by using a specialized manual hand tool or power tool. Any of a number of conventional tools can be used to form a proper seal.

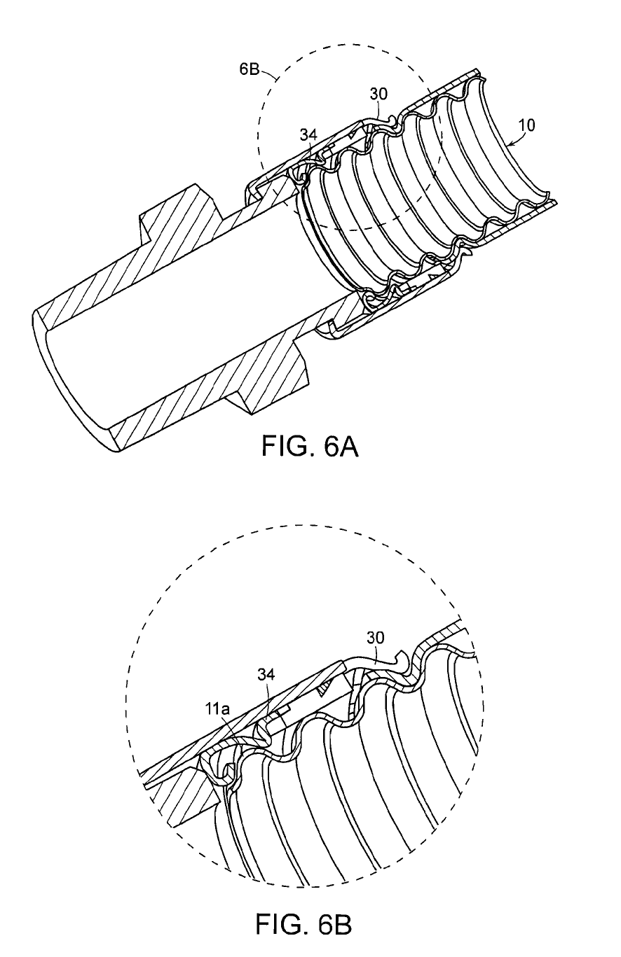

FIGS. 6A and 6B depict another preferred embodiment of the invention in which the sealing ring is formed with an alternate geometry. As shown in FIG. 6B, instead of being formed with an arc-like portion and having a generally closed configuration, a sealing ring 34 according to FIGS. 6A-6B has a generally open configuration, where the sealing ring 34 when fully actuated does not engage substantially the entire periphery of the end corrugation 11a of the tubing 10, but rather only partially engages the end corrugation 11a. Moreover, a sealing ring according to the present invention can incorporate other shapes and geometries instead of the specific embodiments disclosed herein.

The above-described quick actuating sealing and locking devices and methods can yield significant benefits. According to the present invention, a length of tubing can be inserted directly into the fitting, and no disassembly of the fitting is required. The tubing is received in a sleeve member which contains at least a sealing ring and a loading ring, the sealing ring being compressible and deformable so as to accommodate at least one end corrugation of the tubing. The loading ring can be actuated to compress the sealing ring, thereby substantially engaging the at least one end corrugation of the tubing. An automatic or manual tool can be used to effect actuation of the loading ring against the sealing ring. Therefore, the quick actuating sealing and locking device and method can provide for ease of assembly and avoid the necessity of delivering large amounts of torque to form an adequate seal.

A method for connecting a length of corrugated tubing to a fitting, comprising the steps of: providing a sleeve member for receiving the tubing, the sleeve member being formed with a compressible sealing ring and a loading ring for engaging the sealing ring; inserting the tubing into the sleeve member; and actuating the loading ring to move axially and compress the sealing ring against at least one corrugation of the tubing. The method can further include steps of: locking the sleeve member against the loading ring, and forming at least one crimp in the sleeve member at an interface between the sleeve member and the tubing.

The present invention also encompasses methods for transporting gas and liquid through piping or tubing, in which at least a length of tubing is sealed to a fitting. The methods can include transporting the gas and liquid to a device, such as a boiler, furnace, or stove.

The present invention further encompasses a method for installing a piping or tubing system in a structure, such as a commercial or residential building, where the installation method includes installing at least a length of tubing that is sealed to a fitting in the manner provided above. For example, the piping or tubing system can utilize CSST tubing and fittings.

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications and other references cited herein are hereby expressly incorporated herein in their entireties by reference.

What is claimed is:

1. A sealing device for connecting a length of corrugated tubing to a fitting, comprising:
the fitting having a sleeve member for receiving the tubing;
a sealing ring received in the sleeve member, the sealing ring configured to be compressed on at least one corrugation of the tubing; and
a loading ring configured to engage the sealing ring and compress the sealing ring against the at least one corrugation of the tubing.

2. The sealing device of claim 1, wherein the tubing is inserted into the fitting such that the at least one corrugation contacts the sealing ring.

3. The sealing device of claim 2, wherein after insertion of the tubing into the fitting, the loading ring is actuated to compress the sealing ring such that the sealing ring substantially engages an entire periphery of the at least one corrugation.

4. The sealing device of claim 1, wherein the sleeve member terminates in a plurality of fingers, and the fingers are configured to engage the tubing.

5. The sealing device of claim 4, wherein the fingers are crimped to the tubing.

6. The sealing device of claim 1, wherein the sealing ring and the loading ring are positioned radially inside the sleeve member.

7. The sealing device of claim 1, wherein the sleeve member and the loading ring include a locking mechanism.

8. The sealing device of claim 7, wherein the locking mechanism includes a plurality of locking tabs on the sleeve member that engage enclosures of the loading ring.

9. The sealing device of claim 1, wherein the length of tubing is covered by a jacket, and a jacket crimp is formed between an end of the sleeve member and the jacket.

10. The sealing device of claim 9, wherein the sleeve member terminates in a plurality of fingers, and the fingers are biased to engage the jacket after the loading ring engages the sealing ring.

11. The sealing device of claim 1, wherein the fitting further includes an adapter, and the adapter is configured to receive the sleeve member.

12. The sealing device of claim 1, wherein the adapter and the sleeve member form an integral component.

13. The sealing device of claim 1, wherein the sealing ring is formed with an arc-like portion.

14. The sealing device of claim 1, wherein the sealing ring has an open configuration such that the sealing ring only partially engages the at least one corrugation of the tubing.

15. The sealing device of claim 1, wherein the fitting is configured to receive an additional length of tubing.

16. A method for connecting a length of corrugated tubing to a fitting, comprising the steps of:
providing a sleeve member for receiving the tubing, the sleeve member being formed with a compressible sealing ring and a loading ring for engaging the sealing ring;
inserting the tubing into the sleeve member; and
actuating the loading ring to engage the sealing ring and compress the sealing ring against at least one corrugation of the tubing.

17. The method of claim 16, wherein the actuating step includes advancing the loading ring axially to engage the sealing ring.

18. The method of claim 16, wherein the actuating step includes gripping the sleeve member with a tool.

19. The method of claim 16, further comprising the step of:
locking the sleeve member against the loading ring.

20. The method of claim 19, wherein the locking step includes engaging locking tabs of the sleeve member with the loading ring.

21. The method of claim 16, further comprising the step of:
forming at least one crimp in the sleeve member at an interface between the sleeve member and the tubing.

22. The method of claim 16, wherein after insertion of the tubing into the fitting, the loading ring is actuated to compress the sealing ring such that the sealing ring substantially engages an entire periphery of the at least one corrugation.

23. The method of claim 16, wherein the sleeve member terminates in a plurality of fingers, and the fingers are configured to engage the tubing.

24. The method of claim 16, wherein the sealing ring and the loading ring are positioned radially inside the sleeve member.

25. The method of claim 16, wherein the fitting further includes an adapter, and the adapter is configured to receive the sleeve member.

26. The method of claim 25, wherein the adapter and the sleeve member form an integral component.

27. The method of claim 16, wherein the sealing ring is formed with an arc-like portion.

28. The method of claim 16, wherein the sealing ring has an open configuration such that the sealing ring only partially engages the at least one corrugation of the tubing.
